(19) United States
(12) Patent Application Publication
(10) Pub. No.: US 2012/0158508 A1
(43) Pub. Date: Jun. 21, 2012

(54) MOBILE ADVERTISING INCLUDING LOCALIZED ADVERTISER BIDDING

(75) Inventors: Jonathan Kilroy, Champaign, IL (US); Dale Nussel, Mahomet, IL (US); Allie K. Watfa, Urbana, IL (US); Anupam Seth, Urbana, IL (US)

(73) Assignee: Yahoo! Inc., Sunnyvale, CA (US)

(21) Appl. No.: 12/973,537

(22) Filed: Dec. 20, 2010

(51) Int. Cl. G06Q 30/00

(52) U.S. Cl. 705/14.58

(57) ABSTRACT

Techniques are provided that include targeting a user of a portable electronic device with an interest-based and location-based advertisement, based at least in part on advertiser bidding. Techniques are provided in which a user is indicated as being at a particular location or within a particular geographic area. An advertisement, such as an electronic coupon or discount offer, may be selected for sending to the user based at least in part on advertiser bidding. The advertisement may relate at least in part to a store or business at the particular location or within the particular area.

### BACKGROUND

Mobile advertising, including advertising in connection with various portable electronic devices, poses many challenges. For example, getting the right advertisement to a particular user at the right time can increase impact on the user, relevance, advertisement performance, and revenue.

There is a need for techniques for advertising in connection with portable electronic devices.

### SUMMARY

Some embodiments of the invention provide systems and methods that include targeting a user of a portable electronic device with an interest-based and location-based advertisement, based at least in part on advertiser bidding. Techniques are provided in which a user is indicated as being at a particular location or within a particular geographic area. An advertisement, such as an electronic coupon or discount offer, may be selected for sending to the user based at least in part on advertiser bidding. The advertisement may relate at least in part to a store or business at the particular location or within the particular area, and may be served to the user while the user is at the particular location or within the particular area. The advertiser bidding may include bids from multiple advertisers and relating to advertising associated at least in part with stores or businesses at the particular location or within the particular area.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

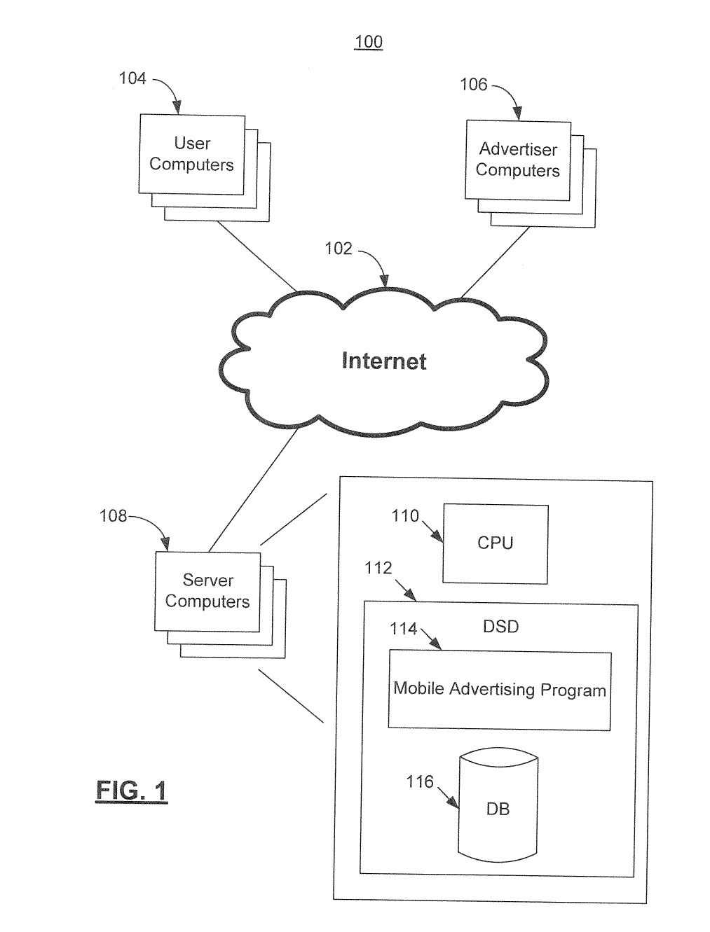

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as PDAs, cell phones, smart phone, wireless computers, wireless computerized devices, laptop computers, tablet computers and computerized devices, electronic reading devices including ebook reader devices, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Mobile Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Herein, the term “advertiser” is broadly intended to include individuals, companies or other entities, and to include agents and proxies of advertisers, other entities acting on behalf, partly on behalf of, or for the benefit of advertisers, etc.

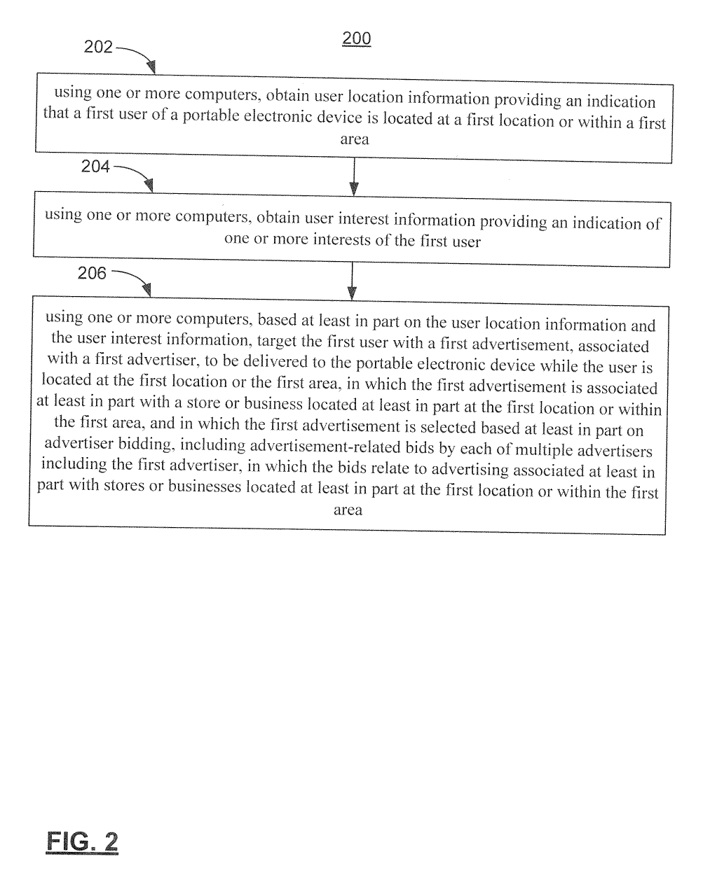

FIG. 2 is a flow diagram illustrating a method 200 according to one embodiment of the invention. At step 202, using one or more computers, user location information is obtained, providing an indication that a first user of a portable electronic device is located at a first location or within a first area.

At step 204, using one or more computers, user interest information is obtained, providing an indication of one or more interests of the first user.

At step 206, using one or more computers, based at least in part on the user location information and the user interest information, the first user is targerted with a first advertisement, associated with a first advertiser, to be delivered to the portable electronic device while the user is located at the first location or within the first area. The first advertisement is associated at least in part with a store or business located at least in part at the first location or within the first area. The first advertisement is selected based at least in part on advertiser bidding, including advertisement-related bids by each of multiple advertisers including the first advertiser. The bids relate to advertising associated at least in part with stores or businesses located at least in part at the first location or within the first area.

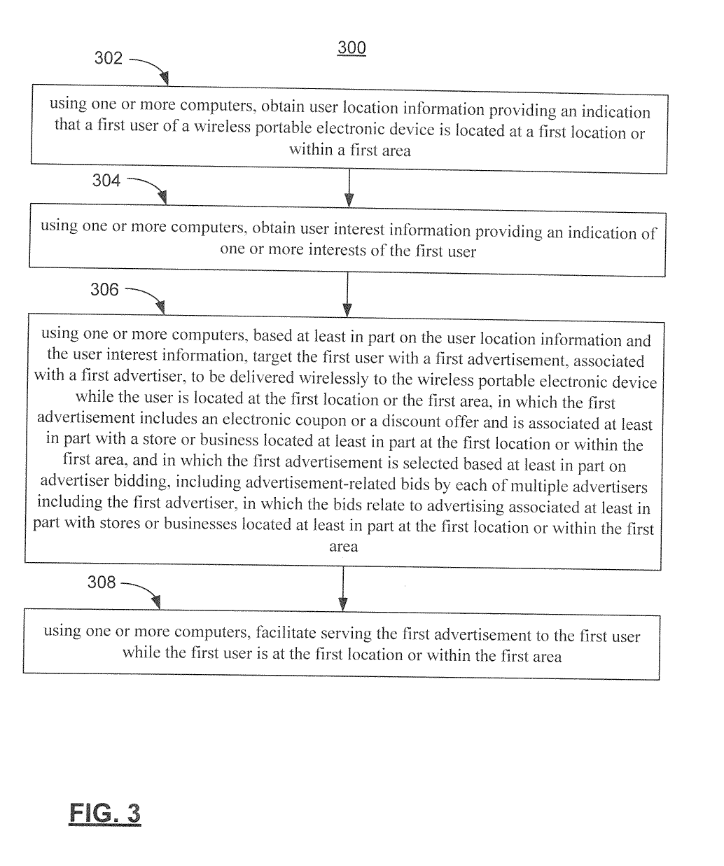

FIG. 3 is a flow diagram illustrating a method 300 according to one embodiment of the invention. At step 302, using one or more computers, user location information is obtained, providing an indication that a first user of a wireless portable electronic device is located at a first location or within a first area.

At step 304, using one or more computers, user interest information is obtained, providing an indication of one or more interests of the first user.

At step 306, using one or more computers, based at least in part on the user location information and the user interest information, the first user is targeted with a first advertisement, associated with a first advertiser, to be delivered wirelessly to the wireless portable electronic device while the user is located at the first location or within the first area. The first advertisement includes an electronic coupon or a discount offer and is associated at least in part with a store or business located at least in part at the first location or within the first area. The first advertisement is selected based at least in part on advertiser bidding, including advertisement-related bids by each of multiple advertisers including the first advertiser. The bids relate to advertising associated at least in part with stores or businesses located at least in part at the first location or within the first area.

At step 308, using one or more computers, the method 300 includes facilitating sending of the first advertisement to the first user while the first user is at the first location or within the first area.

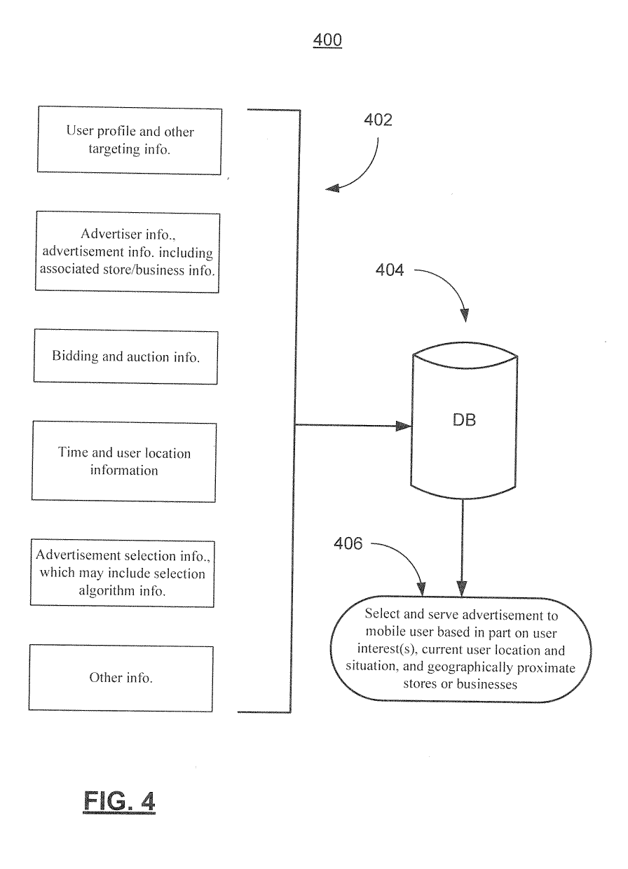

FIG. 4 is a block diagram 400 illustrating one embodiment of the invention. Blocks 402 represent various types of information that is collected, stored in one or more databases 404, and utilized. The information includes user profile and other targeting information; advertiser information and advertisement information including associated store or business information; bidding and auction information; time and user location information; advertisement selection information, which may include advertisement selection algorithms, models, machine learning models, etc.; and various other information.

Block 406 represents selection and sending of an advertisement, such as an electronic coupon or discount offer, to a mobile user, based in part on user interest(s), current or predicted user location and circumstances or situation, and geographically proximate stores and businesses.

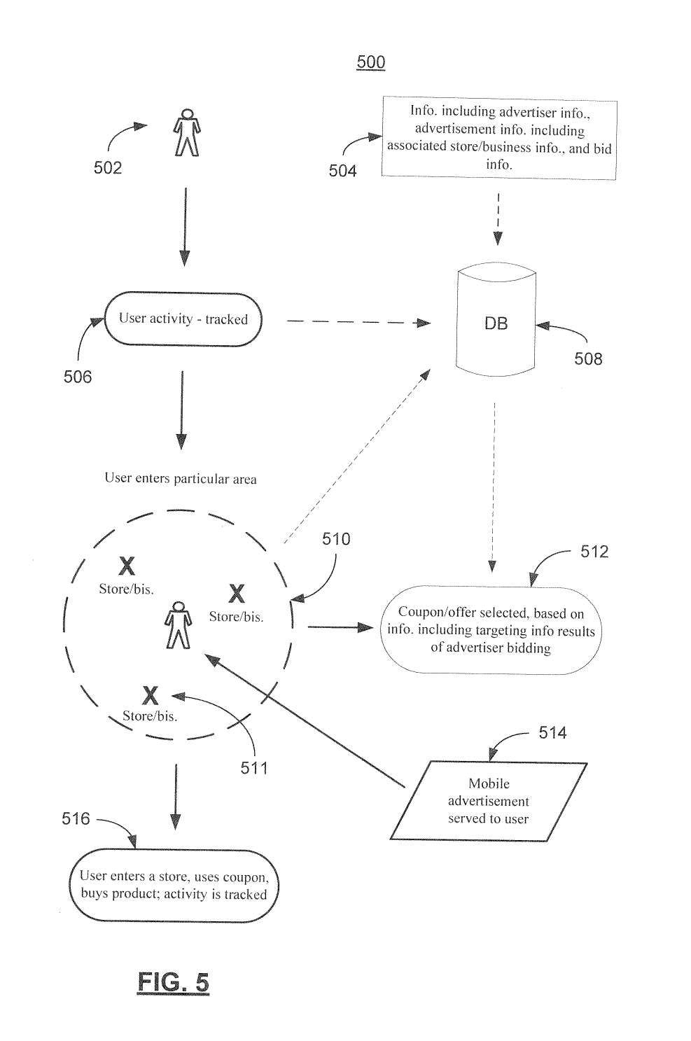

FIG. 5 is a block diagram 500 illustrating one embodiment of the invention. Block 502 represents a portable electronic device user.

Block 506 represents tracked user activity, such as online browsing history, online search history, offline and online purchases, etc. This information 506 is stored in one or more databases 508 along with various other information, which can include, among other things, as represented by block 504, advertiser information, advertisement information including associated store or business information, and bid information.

Block 510 represents the user 502 entering or having entered a particular area 510, such as a geographic area. A number of depicted stores or businesses, such as store or business 511, are also located in the area. Information regarding the area, the user's presence or anticipated presence in the area, the stores and businesses in the area, etc., is stored in the database 508.

As represented by block 512, utilizing information stored in the database 508, as well as potentially various other information, tools, models, algorithms, input, etc., an electronic coupon or discount offer, such as a special offer, etc., is selected for sending to the user 502 while the user 502 is in the area. The electronic coupon or discount offer is selected at least in part based on various targeting information as well as advertiser bidding. The advertiser bidding, or an associated auction, may be implemented in real-time or near-real time, such as after determining that the user has entered the area (or will soon enter the area), and before the user leaves the area. As such, for example, the user may be served an advertisement, to the user's mobile device, which may entice the user to stop in a close-by store while the user is in the area. Advertiser bidding can, in some embodiments, lead to advertisement selection optimization with regard to performance as well as revenue. For example, the advertiser bids can relate to an amount that an advertiser is willing to pay for sending of the advertiser's advertisement. Advertiser bidding and associated auctions of various sorts are contemplates, such as those that are utilized in online advertising, and various forms of online or electronic advertising such as non-search based advertising and search-based advertising, generally.

Some embodiments of the invention can be viewed as providing advantages in merging real-world geographical and physical aspects, including advertising in connection with physical stores, for example, which may be close-by to a user at a particular time, with “virtual” aspects, such as aspects associated with wireless communications and wireless or online advertising generally.

Some embodiments of the invention include a recognition that in search-based online advertising, for example, detecting user interests and user targeting can be relatively easy. Some embodiments of the invention include techniques that can be utilized for non-search-based mobile advertising, although other embodiments can include search and non-mobile advertising. Challenges can include, for example, effectively determining and leveraging user interests, and providing sufficiently appealing and practical mobile advertisements. Some embodiments of the invention utilize various information, which can include user profile and historical communications and online and offline behavior information, to determine user interests. Time and place information may then be utilized to target the user with a currently relevant and locally actionable advertisement, such as a convenient and immediately useable coupon or offer which may be used at a close-by store or business. Additionally, local advertisers, for example, may bid to have their advertisements selected for sending to the user. This competitive bidding situation, such as an auction, can lead to real-time or near-real time selection of an optimized advertisement, leading to optimal advertisement performance and revenue for involved parties, which can include a market-maker or auction facilitator or provider, among other entities.

For example, in some embodiments, various information is collected and utilized to build up profiles of users, which can then be used to determine user interests. The user may, for example, be determined to be interested in buying shoes (which happens to be item that many people may search for online, but be reluctant to actually purchase except in-person at a store). The user may then be determined to be at a shopping mall, which may include several shoe stores. Each of several of the shoe stores may have submitted one or more bids, or may submit bids in real-time or near real-time, to have an electronic coupon for the particular store, for example, served to the mobile device of the user while the user is at the mall and conveniently and immediately able to use the coupon. The selected advertisement is served to the user, which may entice the user to immediately make a purchase at the store. Of course, other interests of the user may also be determined, and the bid competition could include numerous subjects, etc. Many variations and layers of complexity are possible and contemplated.

Some embodiment proposes provide techniques relating to speculative or competitive bidding and time-sensitive geotargeting, to select and provide advertisements such as electronic coupons to mobile users. In some embodiments, for example, for a user determined to be interested in a product and who is determined to have entered, or to be about to enter, a particular area, the user will be treated with an advertisement including a best fit deal or coupon to use in purchasing the product in the area. In some embodiments, advertiser bidding can be analogous to advertiser bidding in a sponsored search context, for example. In some embodiments, local stores can bid in connection with real-time geolocation of users, and the winning bidder can have an advertisement targeted to mobile device user, drawing or luring the user to make a purchase of the advertiser's product. Of course, in some embodiments, bid may be only one factor in many factors considered in advertisement selection. Additional factors can include, for instance, various targeting criteria, predicted or forecasted advertisement performance, anticipated revenue associated with the advertisement, including revenue for a marketplace facilitator, etc. In some embodiments, any of various algorithms, models, etc., can be used in advertisement selection, for optimized advertisement selection. Furthermore, in some embodiments, the number of advertisements served to the user while the user is in an area, or for a particular period of time, etc., is limited so as not to annoy, overwhelm or bombard the user with advertisements. Limited, optimized advertisements may be served, maximizing served advertisement performance by sending advertisements that match a user's immediate needs or interests and which are immediately and conveniently actionable.

Some embodiments include a recognition that many users often perform searching in a investigation mode and are not quite convinced that they should buy yet, or may not wish to buy online, or both. Often, the user may do research at home in connection with paper or online coupons. Users who may be on the go with a mobile device, however, for example, such as users in a shopping mall or shopping area or district, may not have the “bandwidth” or convenient ability to, proactively and on their own information and initiative, look for or search for deals that they can use in local stores. Furthermore, printing, which may be helpful or needed in such situations, will likely not be available or convenient. Some embodiments of the invention, by contract, bring the best deal to user in purely electronic, convenient fashion, optimized, for example, through advertiser bidding, targeted to the user's current interests, and available for immediate use at a currently close-by store or business, for example.

For example, in some embodiments, the system may detect that a user is in the vicinity of an airport following a flight to destination away from the user's home. The system may use competitive bidding from hotels in the area, and a selected coupon for the winning hotel/advertiser may be served to the mobile device of the user.

As another example, a user might be determined to be in a section of town including many restaurants at about noon. The system may serve a winning, competitively selected advertisement relating to a lunch deal at a local restaurant. Similarly, a user driving past a movie theatre could be shown a competitively selected advertisement relating to a movie that also fits the interests or profile of the user. As another example, a user walking in the morning could be served a competitively selected and suitable coupon relating to a new coffee blend being offered at a local coffee shop. As another example, a user determined to be approaching a gas station could be served a competitively selected bid offering a free car wash with a fill up.

As another example, it may be detected that a user is interested in buying a watch. The system may detect the user's proximity to stores such as Kohl's, Bergner's etc. The system may also detect and utilize time-based factors, such as day of week, time of day, and seasonal considerations. Other factors, such as emotional targeting, may also be utilized. The user's interest may be measured, including use of information regarding online and offline patterns or habits, in addition to the geographical, temporal, and other factors and other considerations. The system may search for coupons from online retailers such as Amazon, Rolex, etc. and, based at least in part on bidding, may select and send a coupon to the user.

Some embodiments of the invention include a number of detection, determination or calculation steps. Such steps can include elements relating to geodetection, time detection, interest detection, competitive bidding determination or calculation, and advertisement, coupon or deal selection and determination, and in some embodiments may be performed in the foregoing order or prioritization order.

Some embodiments of the invention use various techniques and factors, and combinations of techniques and factors, for user interest detection, including detecting what a user may be interested in purchasing.

For example, in some embodiments, a user's online search query history may be utilized in interest detection. For example, in some embodiments, techniques may include mapping of search queries to a user profile. Often, a user will do some online searching online before heading to the local store location. As such, collecting information regarding and mapping search history and time of a user's trip to a mall, for example, can be used in interest detection, and anticipated shopping.

Furthermore, online shopping-relating information can be utilized in interest detection and anticipated purchasing. This can include, in addition to online purchases, shopping carts on sites such as Amazon, wish lists, watch lists or watched or monitored items on sites like Ebay, etc.

Furthermore, activities and groups of activities can be used in interest detection. For example, online and offline activities in connection with an upcoming trip, including travel arrangements, hotel arrangements, entertainment arrangements, etc., can lead to interest detect insights which can be leveraged when the user is shopping, etc.

Still further, available emails, IMs, and other electronic communications can be mined to aid in interest detection, including associated timeline recognition or prediction.

In some embodiments, utilizing a combination of the above in interest detection can provide various indications, such as, for example, what the user may be planning to buy, register for, or sign up for in the foreseeable future. In some embodiments, the data, per user, may be forwarded to a server system to, for example, allow creation a hash table or hash map of each user's interests, such as may include what products or service are intended to be purchased by the user, etc. Combining the hash table with time and location, the bidding process can be implemented, etc.

The following is an example of some aspects of advertiser bidding according to some embodiments. Company X, Y and Z may bid to show their electronic coupon to any consumer that enters a particular geo-vicinity. Which coupon from which company will be sent to consumer mobile device may be determined at least in part based on the output of the bidding. A limiting number or frequency of advertisements sent, so the user will not be annoyed by being bombarded by too many such advertisements.

In some embodiments, various factors and weightings can be applied. For example, the following weighted factors or strategies, or a combination of them, can be used in selecting the deals or coupons to show to the user. As one strategy or factor, a first come, first serve basis could be utilized, in which the earliest submitted bid will be in the front of the queue or given an advantage. As another strategy or factor, a count, or tokens, can be associated with the advertiser, and as the user or users are shown each the advertisement of the producer, the token count may be decreased, and when no remaining tokens are available, no more advertisements from that advertiser will be selected. As another strategy or factor, the highest bidder can be provided with an advantage or a better chance to win the selection. As another strategy or factor, the closest match between an advertisement and a user's interests or profile can be given an advantage. As another factor, if feedback has been collected from a user or users regarding a particular advertiser, this can be taken into account in advertisement selection. Of course, various algorithms or formulas may be used in weighting and combining factors.

In some embodiments, multiple advertisements may be shown to a user, and may selected and/or ordered in time based on a value, such as a bidding value, associated with each candidate advertisement, where, for example, a higher bidding value will lead to an increased chance of selection, or better-performing or earlier ordering, positioning, etc. Furthermore, in some embodiments, various formulas or algorithms may be used, in which terms represent factors or combinations of factors.

As just one example, one potential bid value formula could be the following, where Wx, Wy and Wz are weighting factors:

Bid Value=(Binary value for highest bid)(Wx)+(Binary value for first come)(Wy)+(Geo-position difference from advertiser)+(Feedback points/Wz)−tokens. (Eq. 1)

In some embodiments, various triggers can be utilized, in various orders, to set in motion such things as advertisement bidding, selection, and sending, such as a geolocation trigger, a time trigger, a bid value trigger, and an interest trigger, which may be identified at least in part using a hash table or map, for example.

In some embodiments, an advertisement, such an electronic coupon or deal, may then be selected based at least in part on bidding.

Following selection, the coupon may be sent to the user. As just one of many possible examples, the coupon may be send via SMS, and may include a bar code or other code for scanning or other reading or accepting at a store.

In some embodiments, if the user makes a purchase using the coupon, this information is fed back into the system and may be utilized for future selection optimization and for other purposes. Furthermore, the user may be provided with an opportunity to provide additional feedback on the coupon, the advertiser, the purchased product, etc., which feedback may also be stored and utilized.

In some embodiments, users are provided with an opportunity to opt out of receiving mobile advertisements, or may be offered an incentive for participation.

While the invention is described with reference to the above drawings, the drawings are intended to be illustrative, and the invention contemplates other embodiments within the spirit of the invention.

1. A method comprising:
using one or more computers, obtaining user location information providing an indication that a first user of a portable electronic device is located at a first location or within a first area;
using one or more computers, obtaining user interest information providing an indication of one or more interests of the first user; and
using one or more computers, based at least in part on the user location information and the user interest information, targeting the first user with a first advertisement, associated with a first advertiser, to be delivered to the portable electronic device while the user is located at the first location or within the first area,
wherein the first advertisement is associated at least in part with a store or business located at least in part at the first location or within the first area; and
wherein the first advertisement is selected based at least in part on advertiser bidding, including advertisement-related bids by each of multiple advertisers including the first advertiser, wherein the bids relate to advertising associated at least in part with stores or businesses located at least in part at the first location or within the first area.

2. The method of claim 1, comprising targeting the first user with the first advertisement, wherein the first advertisement comprises an electronic coupon.

3. The method of claim 1, comprising targeting the first user with the first advertisement, wherein the first advertisement comprises a discount offer relating to a potential offline purchase at the store or the business.

4. The method of claim 1, comprising facilitating sending of the first advertisement to the first user.

5. The method of claim 1, wherein the portable electronic device is a wireless portable electronic device, and comprising facilitating wirelessly sending the first advertisement to the first user.

6. The method of claim 1, comprising sending the first advertisement to the first user while the first user is at the first location or within the first area.

7. The method of claim 1, wherein the user interest information is obtained at least in part based on user profile information.

8. The method of claim 1, wherein the user interest information is obtained at least in part based on user profile information, and wherein the user profile information comprises information relating to past online behavior.

9. The method of claim 1, wherein the user interest information is obtained at least in part based on user profile information, and wherein the user profile information comprises information relating to offline behavior.

10. The method of claim 1, wherein the user interest information is obtained at least in part based on user profile information, and wherein the user profile information comprises online search information.

11. The method of claim 1, comprising targeting the first user with the first advertisement based at least in part on historical purchasing information.

12. The method of claim 1, comprising targeting the first user with the first advertisement, wherein the portable electronic device comprises a cell phone, wireless computer, or wireless computerized device.

13. A system comprising:
one or more server computers coupled to a network; and
one or more databases coupled to the one or more server computers;
wherein the one or more server computers are for:
obtaining user location information providing an indication that a first user of a portable electronic device is located at a first location or within a first area;
obtaining user interest information providing an indication of one or more interests of the first user; and
based at least in part on the user location information and the user interest information, targeting the first user with a first advertisement, associated with a first advertiser, to be delivered to the portable electronic device while the user is located at the first location or within the first area,
wherein the first advertisement is associated at least in part with a store or business located at least in part at the first location or within the first area; and
wherein the first advertisement is selected based at least in part on advertiser bidding, including advertisement-related bids by each of multiple advertisers including the first advertiser, wherein the bids relate to advertising associated at least in part with stores or businesses located at least in part at the first location or within the first area.

14. The system of claim 13, comprising facilitating wirelessly sending the first advertisement to the first user.

15. The system of claim 13, comprising wirelessly sending the first advertisement to the first user.

16. The system of claim 13, wherein at least one of the one or more server computers is coupled to the Internet.

17. The system of claim 13, wherein at least one of the one or more server computers is coupled to the Internet, and wherein the first advertisement is an online advertisement.

18. The system of claim 13, comprising targeting the first user with the first advertisement, wherein the first advertisement comprises an electronic coupon.

19. The system of claim 13, comprising targeting the first user with the first advertisement, wherein the first advertisement comprises a discount offer relating to a potential offline purchase at the store or the business.

20. A computer readable medium or media containing instructions for executing a method comprising:
using one or more computers, obtaining user location information providing an indication that a first user of a wireless portable electronic device is located at a first location or within a first area;
using one or more computers, obtaining user interest information providing an indication of one or more interests of the first user;
using one or more computers, based at least in part on the user location information and the user interest information, targeting the first user with a first advertisement, associated with a first advertiser, to be delivered wirelessly to the wireless portable electronic device while the user is located at the first location or within the first area,
wherein the first advertisement comprises an electronic coupon or a discount offer and is associated at least in part with a store or business located at least in part at the first location or within the first area; and
wherein the first advertisement is selected based at least in part on advertiser bidding, including advertisement-related bids by each of multiple advertisers including the first advertiser, wherein the bids relate to advertising associated at least in part with stores or businesses located at least in part at the first location or within the first area; and
using one or more computers, facilitating sending the first advertisement to the first user while the first user is at the first location or within the first area.
